(19) United States
(12) Patent Application Publication
(10) Pub. No.: US 2015/0145810 A1
(43) Pub. Date: May 28, 2015

(54) TOUCH PANEL

(71) Applicant: TIANJIN FUNAYUANCHUANG TECHNOLOGY CO., LTD., Tianjin (CN)

(72) Inventors: PO-SHENG SHIH, New Taipei (TW); CHIH-HAN CHAO, New Taipei (TW)

(21) Appl. No.: 14/316,811

(22) Filed: Jun. 27, 2014

(30) Foreign Application Priority Data
Nov. 26, 2013 (CN) 2013106055713

(51) Int. Cl. G06F 3/041; G06F 3/046; G06F 3/044

(52) U.S. Cl. CPC G06F 3/0416; G06F 3/044; G06F 3/046; G06F 2203/04106
USPC 345/174

(57) ABSTRACT

A hybrid touch panel is provided. The touch panel includes a sensing module and a control module. The sensing module is composed of a first conductive layer and a second conductive layer. The first conductive layer includes a number of first electrodes spaced from each other. The second conductive layer includes a number of second electrodes spaced from each other. The control module is used to drive and detect the sensing module. The control module includes a switching circuit. The sensing module is capable of being switched between an electromagnetic sensing module and a capacitive sensing module via the switching circuit. The switching circuit is capable of connecting each two of the plurality of first electrodes and each two of the second electrodes to form a number of closed transverse sensing coils and a number of closed vertical sensing coils.

This application claims all benefits accruing under 35 U.S.C. §119 from China Patent Application No. 201310605571.3, filed on Nov. 26, 2013 in the China Intellectual Property Office, the contents of which are hereby incorporated by reference.

### BACKGROUND

1. Technical Field

The present disclosure relates to a touch panel and, particularly, the touch panel has hybrid types of capacitance and electromagnetism.

2. Description of Related Art

In recent years, various electronic apparatuses such as mobile phones, car navigation systems have advanced toward high performance and diversification. There is continuous growth in the number of electronic apparatuses equipped with optically transparent touch panels in front of their display devices such as liquid crystal panels. A user of such electronic apparatus operates it by pressing a touch panel with a grounded object, e.g. a finger or a stylus, while visually observing the display device through the touch panel.

According to working principle and transmission medium, touch panel has five types of resistance, capacitance, infra-red, surface acoustic-wave, and electromagnetism. Capacitive touch panel has been widely used for higher sensitivity and less touch pressure required. However, a resolution of the capacitive touch panel cannot be larger than 500 dpi. Electromagnetic touch panel has a large resolution. A hybrid touch panel of capacitance and electromagnetism is researched. However, the hybrid touch panel has a large thickness, thereby causing inconvenience to users.

What is needed, therefore, is a hybrid touch panel with a small thickness that can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a structure view of a touch panel.

FIG. 2 is a structure view of a sensing module of a touch panel.

FIG. 3 is a structure view of a charging wiring module of a touch panel.

FIG. 4 is a view of a model of a touch panel on working.

FIG. 5 and FIG. 6 are views of switching circuit on working of a touch panel.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

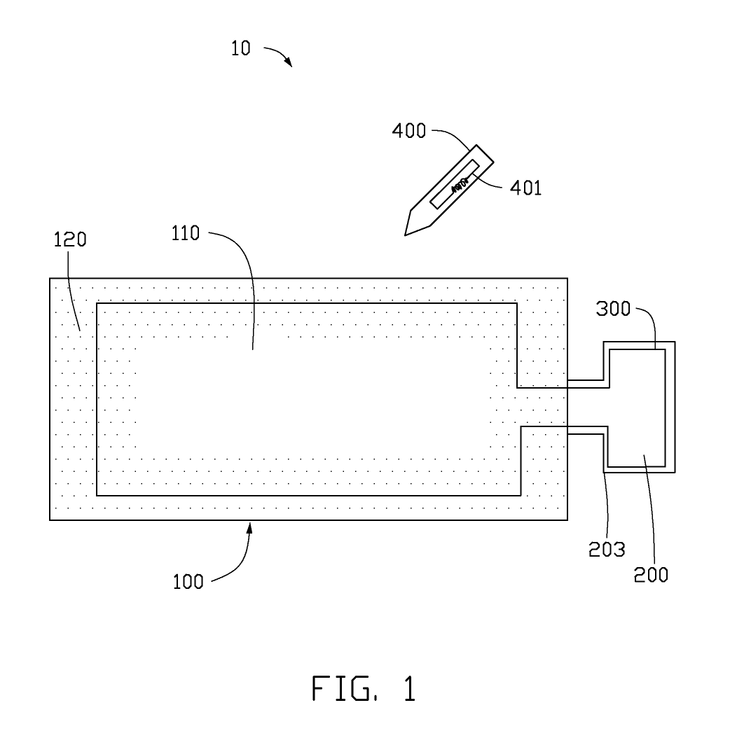

Referring to FIG. 1, a touch panel 10 is provided. The touch panel 10 has hybrid working types of capacitance and electromagnetism. The touch panel 10 comprises a sensing module 100, a control module 200, and a charging wiring module 300. The sensing module 100 is electrically connected with the control module 200. The sensing module 100 is used to detect changes of capacitive signal values or electromagnetic signal values. The control module 200 drives the sensing module 100.

A middle part of the sensing module 100 is defined as an effective touching and control region 110. A periphery part of the sensing module 100 is defined as a non-effective touching and control region 120. The non-effective touching and control region 120 surrounds the effective touching and control region 110. The charging wiring module 300 is arranged on the non-effective touching and control region 120. The effective touching and control region 110 is located inside of the charging wiring module 300.

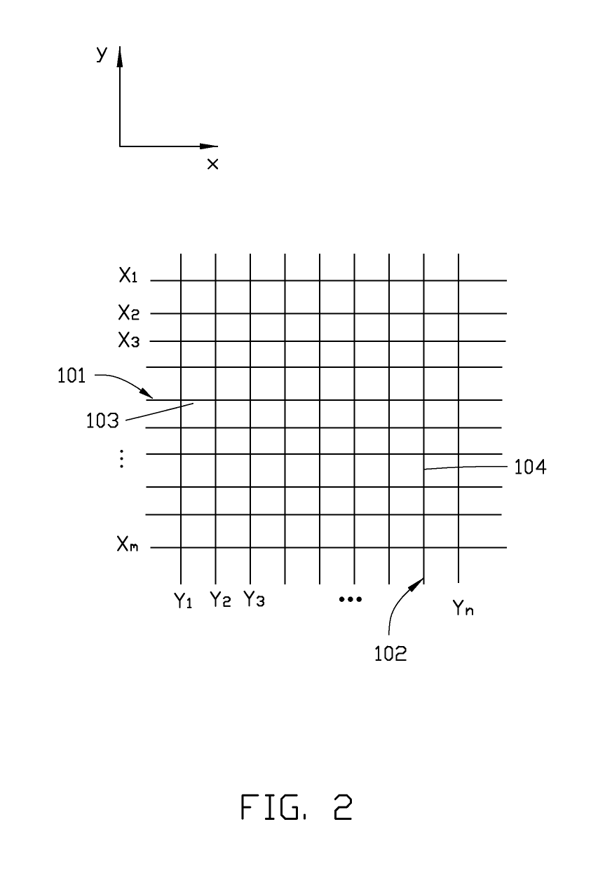

Referring to FIG. 2, the effective touching and control region 110 is composed of a first conductive layer 101 and a second conductive layer 102. The first conductive layer 101 is insulated with and spaced from the second conductive layer 102. The first conductive layer 101 comprises a plurality of first electrodes 103. The second conductive layer 102 comprises a plurality of second electrodes 104. The plurality of first electrodes 103 and the plurality of second electrodes 104 are used to obtain touching position.

The plurality of first electrodes 103 extend substantially along a first direction and are spaced from each other. The plurality of second electrodes 104 substantially extend along a second direction and are spaced from each other. The plurality of first electrodes 103 are labeled by Xₘ according to an arranging order of the plurality of first electrodes 103. The m is a positive integer. The plurality of second electrodes 104 are labeled by Yₙ according to an arranging order of the plurality of second electrodes 104. The n is a positive integer. The plurality of first electrodes 103 are electrically connected with the control module 200. The plurality of second electrodes 104 are electrically connected with the control module 200.

In one embodiment, the plurality of first electrodes 103 and the plurality of second electrodes 104 are bar shaped, the plurality of first electrodes 103 are spaced from and parallel with each other, the plurality of second electrodes 104 are spaced from and parallel with each other, and the first direction is substantially perpendicular to the second direction. Material of the plurality of first electrodes 103 and the plurality of second electrodes 104 can be carbon nanotubes or indium tin oxide. In one embodiment, the material of the plurality of first electrodes 103 and the plurality of second electrodes 104 is carbon nanotubes.

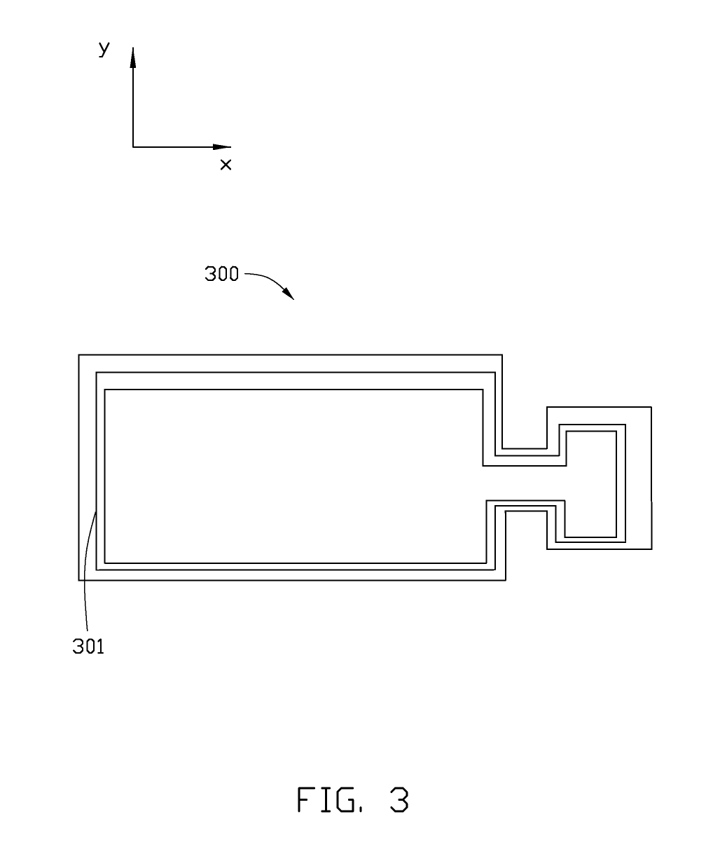

Referring to FIG. 3, the charging wiring module 300 comprises at least one closed coil 301. When the charging wiring module 300 comprises a plurality of closed coils 301, the plurality of closed coils 301 are concentric and spaced from each other. A first part of the plurality of closed coils 301 can be arranged on periphery of the sensing module 100. A second part of the plurality of closed coils 301 can extend from the first part of the plurality of closed coils 301 to surround the control module 200. The charging wiring module 300 is electrically connected with the control module 200. The control module 200 is capable of switching to drive the charging wiring module 300. When the touch panel 10 works with the type of electromagnetism, the charging wiring module 300 would be driven by the control module 200 and charged. When the touch panel 10 works with the type of capacitance, the charging wiring module 300 would not be driven by the control module 200.

Because the charging wiring module 300 is arranged on the non-effective touching and control region 120, the charging wiring module 300 is not overlapped with both the plurality of first electrodes 103 and the plurality of second electrodes 104 along a direction of thickness of the sensing module 100. Thus, the plurality of first electrodes 103 and the plurality of second electrodes 104 would not be interfered. A position of touching by mistake is avoided. Accuracy and sensitivity of the touch panel 10 are improved.

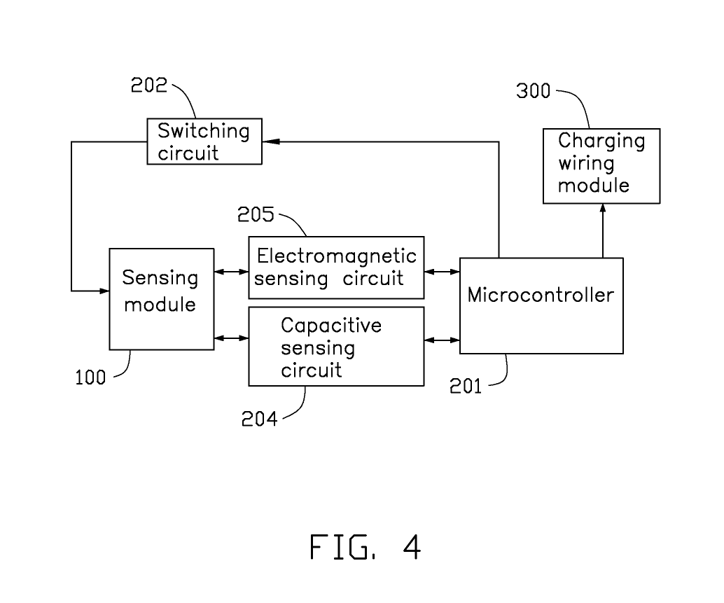

Referring to FIG. 1 and FIG. 4, the control module 200 comprises a microcontroller 201, a switching circuit 202, a capacitive sensing circuit 204, and an electromagnetic sensing circuit 205. The control module 200 is located on a substrate 203. In one embodiment, the control module 200 is located on a middle region of the substrate 203.

The control module 200 can be located outside of the charging wiring module 300. All of the charging wiring module 300 can be located on the non-effective touching and control region 120.

The microcontroller 201 controls the charging wiring module 300, the capacitive sensing circuit 204, and the electromagnetic sensing circuit 205. The sensing module 100 is connected with the microcontroller 201 via the switching circuit 202. The sensing module 100 can be switched between an electromagnetic sensing module and a capacitive sensing module via the switching circuit 202. The capacitive sensing circuit 204 and the electromagnetic sensing circuit 205 are used to transfer sensing signals of the sensing module 100 to the microcontroller 201. A position of touching is calculated by the microcontroller 201. The microcontroller 201 is connected with the charging wiring module 300 via a conductive wire to control the charging wiring module 300 to be on or off.

The switching circuit 202, the capacitive sensing circuit 204, and the electromagnetic sensing circuit 205 can be located on the substrate 203 or the non-effective touching and control region 120.

One end of the sensing module 100 is connected with the switching circuit 202. The other end of the sensing module 100 is connected with the capacitive sensing module and electromagnetic sensing module. When the sensing module 100 is switched to the capacitive sensing module, the capacitive sensing circuit 204 receives capacitance values of the sensing module 100 and transfers the capacitance values to the microcontroller 201, and the position of touching is calculated by the microcontroller 201. When the sensing module 100 is switched to the electromagnetic sensing module, the electromagnetic sensing circuit 205 obtains electromagnetic values of the sensing module 100 and transfers the electromagnetic values to the microcontroller 201, and the position of touching is calculated by the microcontroller 201.

The substrate 203 is an insulating substrate having a property of electric insulation. The material of the insulating substrate can be rigid materials, such as glass, crystal, ceramic, diamond, silicon dioxide, and printed wiring board, or flexible materials such as plastic or resin. In detail, the flexible material can be polycarbonate (PC), polymethyl methacrylate acrylic (PMMA), polyethylene terephthalate (PET), polyethersulfone (PES), cellulose ester, polyvinyl chloride (PVC), benzocyclobutenes (BCB), acrylic resins, acrylonitrile butadiene styrene (ABS), polyamide (PA), or combination thereof. In one embodiment, the material of the substrate 203 is PET.

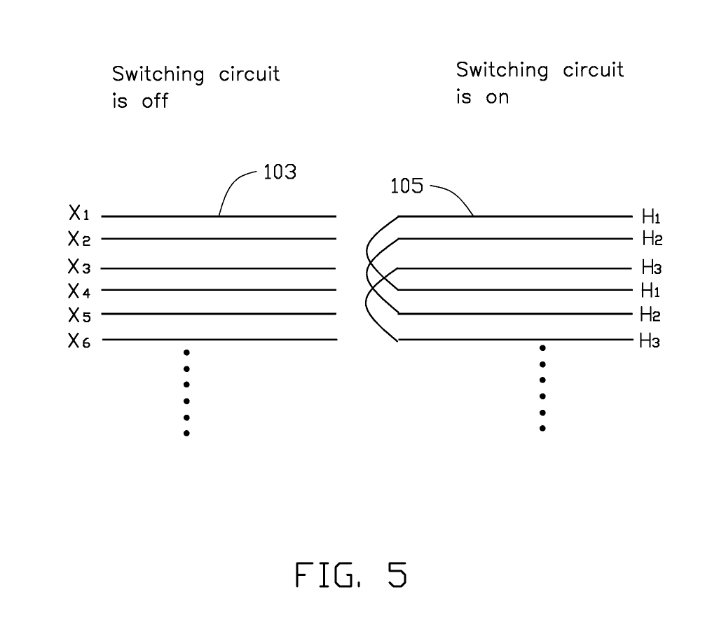

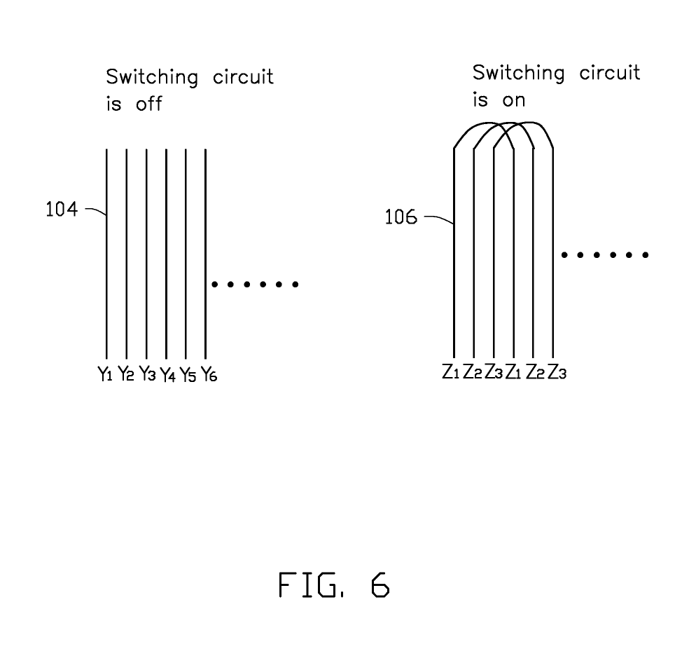

Referring to FIGS. 5-6, when the microcontroller 201 sends a first signal to the switching circuit 202, the switching circuit 202 is on, and each two of the plurality of first electrodes 103 are connected to a plurality of closed transverse sensing coils 105 and each two of the plurality of second electrodes 104 are connected to a plurality of closed vertical sensing coils 106. The sensing module 100 enters the sensing mode of electromagnetism.

Referring to FIG. 5, two of the plurality of first electrodes 103 labeled as X₁ and X₄ are connected by the switching circuit 202 to form a closed transverse sensing coil 105 labeled as H₁. Thus, a plurality of closed transverse sensing coils 105 labeled as Hₖ are obtained. The k is a positive integer. Referring to FIG. 6, two of the plurality of second electrodes 104 labeled as Y₁ and Y₄ are connected by the switching circuit 202 to form a closed vertical sensing coil 106 labeled as Z₁. Thus, a plurality of closed vertical sensing coils 106 labeled as Zⱼ are obtained. The j is a positive integer. The plurality of closed transverse sensing coils 105 and the plurality of closed vertical sensing coils 106 are used as an antenna.

At the same time, the charging wiring module 300 is driven by the microcontroller 201 and an alternative electromagnetic field is produced by the charging wiring module 300. An electromagnetic pen 400 is charged through a resonant circuit 401 in the alternative electromagnetic field. The electromagnetic pen 400 sends an electromagnetic signal to the antenna. The electromagnetic signal received by the antenna is transferred to the microcontroller 201 via the electromagnetic sensing circuit 205.

When the microcontroller 201 sends a second signal to the switching circuit 202, the switching circuit 202 is off, the plurality of first electrodes 103 are disconnected and spaced with each other, and the plurality of second electrodes 104 are disconnected and spaced with each other. The sensing module 100 enters the sensing mode of capacitance.

The capacitive sensing module can be self-inductance capacitance sensing mode or mutual-inductance capacitance sensing mode. In one embodiment, the capacitive sensing module is a mutual-inductance capacitance sensing module, the plurality of first electrodes 103 intersect with the plurality of second electrodes 104 to define a plurality of sensing positions, and a plurality of mutual-inductance capacitances is formed between the plurality of first electrodes 103 and the plurality of second electrodes 104.

The switching circuit 202 can be electronic switch such as a transistor or an integrated circuit chip. Each of the plurality of first electrodes 103 has a first end connected with the switching circuit 202 and a second end opposite to the first end and connected with the capacitive sensing module and electromagnetic sensing module. Each of the plurality of second electrodes 104 has a third end connected with the switching circuit 202 and a fourth end opposite to the third end and connected with the capacitive sensing module and electromagnetic sensing module. The switching circuit 202 is an integrated circuit chip capable of connecting or disconnecting each two of the plurality of first electrodes 103 or each two of the plurality of second electrodes 104.

A capacitive pen can be provided. When the sensing module 100 is changed to the capacitive sensing module, the capacitive pen can be charged by the charging wiring module 300.

The touch panel 10 has following advantages. First, the sensing module 100 consists of two conductive layers, and the two conductive layers are used as capacitance sensing module or electromagnetism sensing module at different times, thereby omitting additional conductive layers and reducing total thickness of the touch panel 10. Second, the charging wiring module 300 is located on the non-effective touching and control region 120. The effective touching and control region 110 is prevented to be interfered. A position of touching mistakenly is avoided and accuracy and sensitivity of the touch panel 10 is improved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure.

What is claimed is:

1. A touch panel comprising:
a sensing module configured for sensing changes of capacitive signal values or electromagnetic signal values; wherein the sensing module consists of a first conductive layer and a second conductive layer, insulated and spaced from the first conductive layer; the first conductive layer comprises a plurality of first electrodes, the plurality of first electrodes substantially extend along a first direction and are spaced from each other; and the second conductive layer comprises a plurality of second electrodes, the plurality of second electrodes substantially extend along a second direction and are spaced from each other; and
a control module configured for driving and detecting the sensing module, wherein the control module comprises a switching circuit; the sensing module is capable of being switched between an electromagnetic sensing module and a capacitive sensing module via the switching circuit; and the switching circuit is capable of connecting each two of the plurality of first electrodes to form a plurality of closed transverse sensing coils and connecting each two of the plurality of second electrodes to form a plurality of closed vertical sensing coils.

2. The touch panel of claim 1, wherein the first direction is substantially perpendicular to the second direction.

3. The touch panel of claim 2, wherein the control module further comprises a microcontroller, a capacitive sensing circuit, and an electromagnetic sensing circuit; the microcontroller is connected with the sensing module via the switching circuit; and the capacitive sensing circuit and the electromagnetic sensing circuit are used to transfer sensing signals of the sensing module to the microcontroller.

4. The touch panel of claim 3, wherein the touch panel further comprises a charging wiring module arranged around the plurality of first electrodes and the plurality of second electrodes.

5. The touch panel of claim 4, wherein the charging wiring module is capable of charging an electromagnetic pen.

6. The touch panel of claim 4, wherein the charging wiring module is capable of charging a capacitive pen.

7. A touch panel comprising:
a sensing module configured for sensing changes of capacitive signal values or electromagnetic signal values, wherein the sensing module consists of a first conductive layer and a second conductive layer; the first conductive layer is insulated and spaced from the second conductive layer; the first conductive layer comprises a plurality of first electrodes, the plurality of first electrodes substantially extend along a first direction and are spaced from each other; and the second conductive layer comprises a plurality of second electrodes, the plurality of second electrodes substantially extend along a second direction and are spaced from each other;
a control module configured for driving and detecting the sensing module, wherein the control module comprises a switching circuit; the sensing module is capable of being switched between an electromagnetic sensing module and a capacitive sensing module via the switching circuit; and the switching circuit is capable of connecting each two of the plurality of first electrodes to form a plurality of closed transverse sensing coils and connecting each two of the plurality of second electrodes to form a plurality of closed vertical sensing coil; and
a charging wiring module comprising at least one closed coil, wherein the charging wiring module is arranged around the sensing module.

8. The touch panel of claim 7, wherein the charging wiring module is arranged around the plurality of first electrodes and the plurality of second electrodes.
